(19) United States
(12) Patent Application Publication
(10) Pub. No.: US 2025/0039709 A1
(43) Pub. Date: Jan. 30, 2025

(54) WIRELESS TELECOMMUNICATIONS APPARATUSES AND METHODS

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/716,661

(22) PCT Filed: Nov. 22, 2022
(86) PCT No.: PCT/EP2022/082880

§ 371 Date: Jun. 5, 2024

(30) Foreign Application Priority Data
Dec. 30, 2021 (EP) 21218397.4

(51) Int. Cl. H04W 24/08

(52) U.S. Cl. CPC H04W 24/08

(57) ABSTRACT

A wireless telecommunications apparatus, forming a UE, for use in a wireless telecommunications network comprises communication circuitry configured to transmit wireless signals to or receive wireless signals from a first network node, the first network node being a mobile network node and control circuitry configured to determine whether one or more conditions are satisfied and when the one or more conditions are satisfied, to measure a characteristic of a wireless signal received by the communication circuitry from a second, different, network node.

### BACKGROUND

### Field of the Disclosure

The present disclosure relates to wireless telecommunications apparatuses and methods.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Recent generation mobile telecommunication systems, such as those based on the 3^{rd} Generation Partnership Project (3GPP (RTM)) defined Universal Mobile Telecommunications System (UMTS), Long Term Evolution (LTE) and 5G New Radio (NR) architectures, are able to support a wider range of services than simple voice and messaging services offered by previous generations of mobile telecommunication systems. For example, with the improved radio interface and enhanced data rates provided by LTE and NR systems, a user can experience high data rate applications such as mobile video streaming and mobile video conferencing that would previously only have been available via a fixed line data connection.

In addition to supporting these kinds of more sophisticated services and devices, it is also proposed for newer generation mobile telecommunication systems such as NR to support less complex services and devices which make use of the reliable and wide ranging coverage of newer generation mobile telecommunication systems without necessarily needing to rely on the high data rates available in such systems. For example, a less complex device may be a tiny device equipped with sensors and a small battery capacity. Such a less complex device needs to transmit the sensor data at a typically infrequent and/or low data rate.

The demand to deploy such networks is therefore strong and the coverage area of these networks, i.e. geographic locations where access to the networks is possible, may be expected to increase ever more rapidly. There is also a continuing need to improve the network speed, reliability, efficiency and/or flexibility of these networks whilst reducing the power consumption of the devices (in particular, user equipment) in these systems.

### SUMMARY

The present disclosure is defined by the claims. Example embodiments can provide a wireless telecommunications apparatus, such as a user equipment (UE), for use in a wireless telecommunications network comprising communication circuitry configured to transmit wireless signals to or receive wireless signals from a first network node, the first network node being a mobile network node, and control circuitry configured to determine whether one or more conditions are satisfied and when the one or more conditions are satisfied, to measure a characteristic of a wireless signal received by the communication circuitry from a second, different, network node. According to disclosed example embodiments, a performance of UE measurements can depend on the one or more conditions. The condition(s) may be based on, for example, time, UE location and UE connection characteristics with one or more specific network nodes. The UE therefore does not always perform measurements on signals transmitted by all network nodes which can potentially serve the UE. Rather, it only performs measurements when required based on fulfilment of the one or more conditions. This can assist the UE to achieve an appropriate balance between UE measurement performance, allowing a most suitable serving node to be determined, thereby helping maintain UE connectivity with the network through appropriate link switching and/or cell reselection and UE power consumption since UE power consumption is reduced when unnecessary measurements are not performed.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically represents some elements of a LTE-type wireless telecommunications system;

FIG. 2 schematically represents some elements of a NR-type wireless telecommunications system;

FIG. 3 schematically represents some components of the wireless telecommunications system shown in FIG. 2 in more detail;

FIG. 4 schematically represents some elements of a NR-type wireless telecommunications system;

FIG. 5 schematically represents a use case for a mobile network node such as a Vehicle-Mounted Relay (VMR);

FIG. 6 shows a first example method of controlling a wireless telecommunications apparatus; and

FIG. 7 shows a second example method of controlling a wireless telecommunications apparatus.

Like reference numerals designate identical or corresponding parts throughout the drawings.

### DETAILED DESCRIPTION OF THE EMBODIMENTS

### Long Term Evolution (LTE) Wireless Communications System

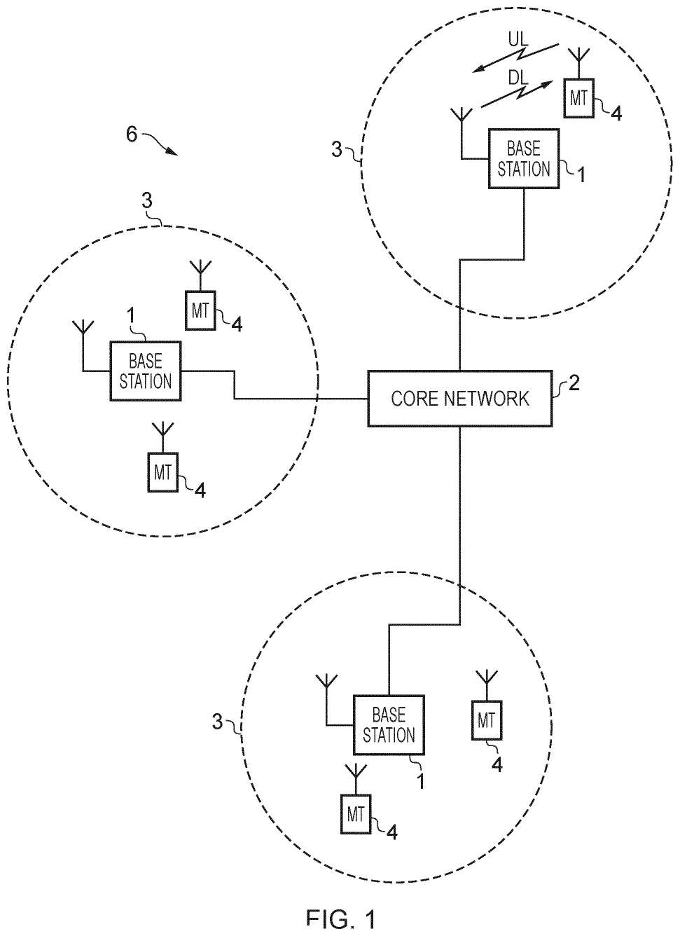

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP body, and also described in many books on the subject, for example, Holma, H. and Toskala, A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. A communications device may also be referred to as a mobile station, user equipment (UE), user terminal, mobile radio, terminal device and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

A base station, which is an example of network infrastructure equipment, may also be referred to as a transceiver station, nodeB, e-nodeB, eNB, g-nodeB, gNB and so forth (note g-nodeB and gNB are related to 5G New Radio—see below). In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

In the present disclosure, any apparatus (e.g. communications device, infrastructure equipment and the like) which transmits and/or receives wireless telecommunications signals in any of the exemplified wireless telecommunication networks/systems may be referred to generally as a wireless telecommunications apparatus.

### 5G New Radio (NR) Wireless Communications System

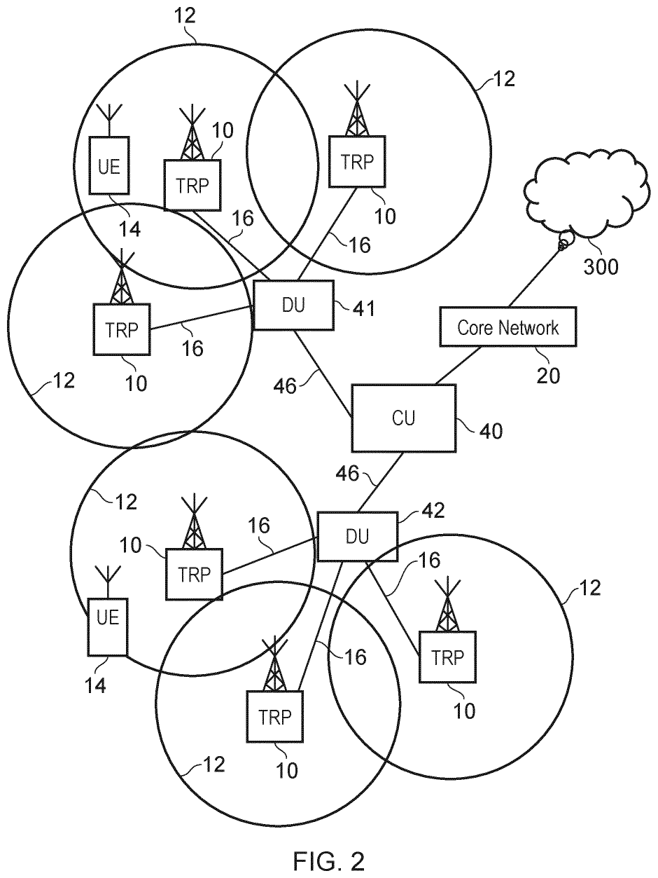

An example configuration of a wireless communications network which uses some of the terminology proposed for NR is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to a core network 20 which may contain all other functions required for communicating data to and from the wireless communications devices and the core network 20. The core network 20 may be connected to other networks 300.

The elements of the wireless access network shown in FIG. 2 may operate in a similar way to corresponding elements of an LTE network as described with regard to the example of FIG. 1. It will be appreciated that operational aspects of the telecommunications network represented in FIG. 2 and of other networks discussed herein in accordance with embodiments of the disclosure which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated, therefore, that operational aspects of an NR network (for example in relation to specific communication protocols and physical channels for communicating between different elements) may be different to those known from LTE or other known mobile telecommunications standards. However, it will also be appreciated that each of the core network component, base stations and communications devices of an NR network will be functionally similar to, respectively, the core network component, base stations and communications devices of an LTE wireless communications network.

In terms of broad top-level functionality, the core network 20 connected to the NR telecommunications system represented in FIG. 2 may be broadly considered to correspond with the core network 2 represented in FIG. 1, and the central unit 40 and associated DUs 41, 42/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the CU 40, DUs 41, 42 and/or TRPs 10. Communications devices 14 are represented in FIG. 2 within the coverage area of respective communication cells 12. These communications devices 14 may thus exchange signalling with the CU 40 via the TRP 10 associated with their respective communication cells 12.

It will further be appreciated that FIG. 2 represents merely one example of a proposed architecture for an NR-based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a CU 40, DU 41, 42 and/or TRP 10 of the kind shown in FIG. 2 which is adapted to provide functionality in accordance with the principles described.

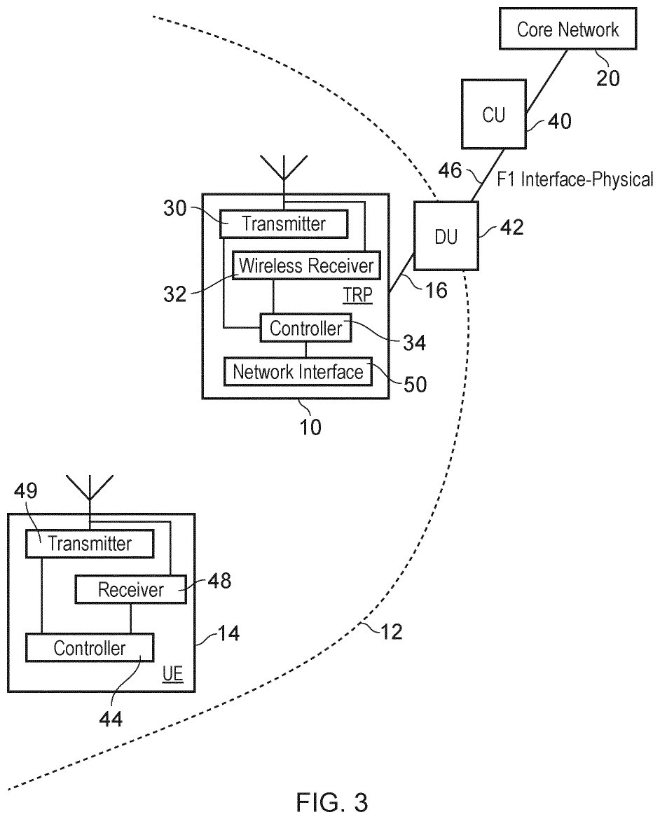

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which is configured to control the transmitter 30 and the receiver 32 to transmit radio signals to and receive radio signals from one or more UEs 14 within a cell 12 formed by the TRP 10. As shown in FIG. 3, an example UE 14 is shown to include a corresponding wireless transmitter 49, wireless receiver 48 and a controller or controlling processor 44 which is configured to control the transmitter 49 to transmit signals representing uplink data to the wireless communications network via the wireless access interface formed by the TRP 10 and the receiver 48 to receive downlink data as signals transmitted by the transmitter 30.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance, for example, with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473 and, for example, may be formed from a fibre optic or other wired high bandwidth connection. In one example, the connection 16 from the TRP 10 to the DU 42 is fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

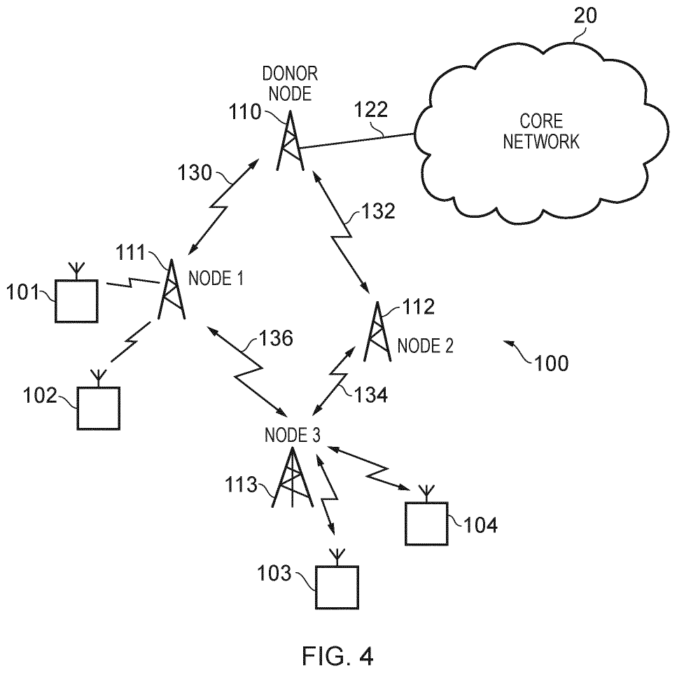

Example arrangements of the present technique can be formed from a wireless communications network corresponding to that shown in FIG. 1 or 2, as shown in FIG. 4. FIG. 4 provides an example in which cells of a wireless communications network are formed from infrastructure equipment which are provided with an Integrated Access and Backhaul (IAB) capability. The wireless communications network 100 comprises the core network 20 and a first, a second, a third and a fourth communications device (respectively 101, 102, 103 and 104) which may broadly correspond to the communications devices 4, 14 described above (and, in particular, comprise the same electronic components as the UE 14 of FIG. 3).

The wireless communications network 100 comprises a radio access network, comprising a first infrastructure equipment 110, a second infrastructure equipment 111, a third infrastructure equipment 112, and a fourth infrastructure equipment 113. Each of the infrastructure equipment provides a coverage area (i.e. a cell, not shown in FIG. 4) within which data can be communicated to and from the communications devices 101 to 104. For example, the fourth infrastructure equipment 113 provides a cell in which the third and fourth communications devices 103 and 104 may obtain service. Data is transmitted from the fourth infrastructure equipment 113 to, for example, the fourth communications device 104 within its respective coverage area (not shown) via a radio downlink. Data is transmitted from, for example, the fourth communications device 104 to the fourth infrastructure equipment 113 via a radio uplink.

The infrastructure equipment 110 to 113 in FIG. 4 may correspond broadly to the TRPs 10 of FIG. 2 and FIG. 3 (and, in particular, comprise the same electronic components as the TRP 10 of FIG. 3).

The first infrastructure equipment 110 in FIG. 4 is connected to the core network 20 by means of one or a series of physical connections 122. The first infrastructure equipment 110 may comprise a TRP 10 having the physical connection 16 to the DU 42 in combination with the DU 42 having the physical connection to the CU 40 by means of the F1 interface 46. The CU 40, in turn, is connected by means of a physical connection (e.g. fibre optic) to the core network 20.

However, there is no direct physical connection between any of the second infrastructure equipment 111, the third infrastructure equipment 112, the fourth infrastructure equipment 113 and the core network 20. As such, it may be necessary or otherwise determined to be appropriate for data received from a communications device (i.e. uplink data) or data for transmission to a communications device (i.e. downlink data) to be transmitted to or from the core network 20 via other infrastructure equipment, such as the first infrastructure equipment 110, which has a physical connection to the core network 20, even if the communications device is not currently served by the first infrastructure equipment 110 but is, for example, in the case of the wireless communications device 104, served by the fourth infrastructure equipment 113.

The second, third and fourth infrastructure equipment 111 to 113 in FIG. 4 may each comprise a TRP, broadly similar in functionality to the TRPs 10 of FIG. 2.

In some arrangements of the present technique, one or more of the second to fourth infrastructure equipment 111 to 113 in FIG. 4 may further comprise a DU 42, and in some arrangements of the present technique, one or more of the second to fourth infrastructure equipment 110 to 113 may comprise a DU and a CU.

In some arrangements of the present technique, the CU 40 associated with the first infrastructure equipment 110 may perform the function of a CU not only in respect of the first infrastructure equipment 110, but also in respect of one or more of the second, the third and the fourth infrastructure equipment 111 to 113.

In order to provide the transmission of the uplink data or the downlink data between a communications device and the core network, a route is determined by any suitable means, with one end of the route being an infrastructure equipment physically connected to a core network and by which uplink and downlink traffic is routed to or from the core network.

In the following, the term ‘node’ is used to refer to an entity or infrastructure equipment which forms a part of a route for the transmission of the uplink data or the downlink data.

An infrastructure equipment which is physically connected to the core network and operated in accordance with an example arrangement which may provide communications resources to other infrastructure equipment is referred to as a ‘donor node’. An infrastructure equipment which acts as an intermediate node (i.e. one which forms a part of the route but is not acting as a donor node) is referred to as a ‘relay node’. It should be noted that although such intermediate node infrastructure equipment acts as relay nodes on the backhaul link, they may also provide service to communications devices. The relay node at the end of the route which is the infrastructure equipment controlling the cell in which the communications device is obtaining service is referred to as an ‘end node’.

Hence, for clarity and conciseness in the following description, the first infrastructure equipment 110 is referred to below as the ‘donor node’, the second infrastructure equipment 111 is referred to below as ‘Node 1’, the third infrastructure equipment 112 is referred to below as ‘Node 2’ and the fourth infrastructure equipment 113 is referred to below as ‘Node 3’.

For the purposes of the present disclosure, the term ‘upstream node’ is used to refer to a node acting as a relay node or a donor node in a route which is a next hop when used for the transmission of data via that route from a wireless communications device to a core network. That is, ‘upstream node’ is used to refer to a relay node or a donor node to which uplink data is transmitted for transmission to a core network. Similarly, ‘downstream node’ is used to refer to a relay node from which uplink data is received for transmission to a core network. For example, if uplink data is transmitted via a route comprising (in order) the Node 3 113, the Node 1 111 and the donor node 110, then the donor node 110 is an upstream node with respect to the Node 1 111, and the Node 3 113 is a downstream node with respect to the Node 1 111.

More than one route may be used for the transmission of the uplink/downlink data from/to a given communications device. This is referred to as ‘multi-connectivity’. For example, the uplink data transmitted by the wireless communications device 104 may be transmitted either via the Node 3 113 and the Node 2 112 to the donor node 110, or via the Node 3 113 and the Node 1 111 to the donor node 110.

The donor node 110 and the second to fourth infrastructure equipment acting as the Nodes 1 to 3 111, 112, 113 may communicate with one or more other nodes by means of one or more inter-node wireless communications links (which may also be referred to “wireless backhaul communications links”). For example, FIG. 4 illustrates four inter-node wireless communications links 130, 132, 134, 136.

Each of the inter-node wireless communications links 130, 132, 134, 136 may be provided by means of a respective wireless access interface. Alternatively, two or more of the inter-node wireless communications links 130, 132, 134, 136 may be provided by means of a common wireless access interface and, in particular, in some arrangements of the present technique, all of the inter-node wireless communications links 130, 132, 134, 136 are provided by a shared wireless access interface.

A wireless access interface, which provides an inter-node wireless communications link, may also be used for communications between an infrastructure equipment and a communications device which is served by the infrastructure equipment. For example, the fourth wireless communications device 104 may communicate with the Node 3 113 using the wireless access interface which provides the inter-node wireless communications link 134 connecting the Node 3 113 and the Node 2 112.

The wireless access interface(s) providing the inter-node wireless communications links 130, 132, 134, 136 may operate according to any appropriate specifications and techniques.

Examples of wireless access interface standards include the 3GPP-specified General Packet Radio Service (GPRS)/Enhanced Data rates for Global Evolution (EDGE) (“2G”), Wideband Code-Division Multiple Access (WCDMA)/Universal Mobile

Telecommunications System (UMTS) and related standards such as High Speed Packet Access (HSPA) and HSPA+ (“3G”), LTE and related standards including LTE-Advanced (LTE-A) (“4G”), and NR and related standards including NR-Advanced (“5G”). Techniques that may be used to provide a wireless access interface include one or more of time-division multiple access (TDMA), frequency-division multiple access (FDMA), orthogonal frequency-division multiple access (OFDMA), single-carrier frequency-division multiple access (SC-FDMA), code-division multiple access (CDMA). Duplexing (i.e. the transmission over a wireless link in two directions) may be by means of frequency division duplexing (FDD) or time division duplexing (TDD) or a combination of both.

In some arrangements of the present technique, two or more of the inter-node wireless communications links 130, 132, 134, 136 may share communications resources. This may be because two or more of the inter-node wireless communications links 130, 132, 134, 136 are provided by means of a single wireless access interface or because two or more of the inter-node wireless communications links 130, 132, 134, 136 nevertheless operate simultaneously using a common range of frequencies. The nature of the inter-node wireless communications links 130, 132, 134, 136 may depend on the architecture by which the wireless backhaul functionality is achieved.

In the described examples, the term “serving node” refers the node which a UE directly transmits wireless uplink signals to or directly receives wireless downlink signals from in order to communication with the network. For example, in FIG. 4, node 111 is the serving node for UEs 101 and 102 and node 113 is the serving node for UEs 103 and 104.

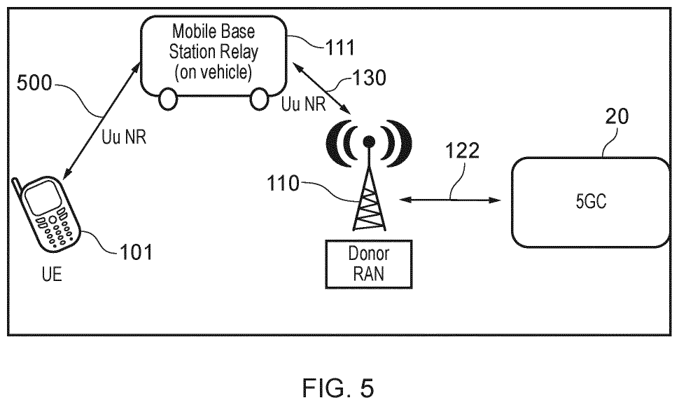

FIG. 5 shows a use case of a network based on the network 100 of FIG. 4 according to embodiment(s). Here, the relay node 111 is a mobile relay node. For example, the relay node 111 is a Vehicle-Mounted Relay (VMR) mounted on a vehicle (e.g. a bus or train) which moves around and connects to different upstream nodes depending on its location. The mobility of the mobile relay node 111 is managed by the core network 20, CU(s) (not shown in FIG. 5), DU(s) (not shown in FIG. 5) and/or other nodes of the network which the mobile relay node 111 is able to connect to via an inter-node wireless communication link. At the point in time of FIG. 5, the mobile relay node 111 has established an inter-node-wireless communication link 130 with donor node 110. Donor node 110 is, in turn, connected to the core network 20 via the one or more physical connections 122. Uplink and downlink data is wirelessly transmitted between the UE 101 and the network via a wireless communication path 500 established between the UE 101 and mobile relay node 111.

Mobile relay nodes such as VMRs and related use cases are discussed in [2], for example. VMR can provide opportunistic boost to cellular coverage and/or capacity when and where needed. They can also help improve the connectivity for UEs inside a vehicle on which a VMR is mounted. It is noted FIG. 5 has been reproduced from [2].

In [2], several VMR-related use cases are discussed along with potential new network requirements needed to support these use cases (in particular, to allow UEs to maintain connectivity with the network via a mobile relay node). One example use case is the network supporting the use of a mobile relay node to provide network access to UEs in the vehicle along the vehicle itinerary. Another example use case is the network providing means to ensure UEs inside a vehicle, once provided with network access and connectivity via a mobile relay node, remain connected via the mobile relay node.

In order to keep connectivity, a UE will usually regularly perform signal measurements of all network nodes which can potentially serve the UE in order to find the most suitable serving node. However, performing these measurements requires power and thus undesirably increases UE power consumption.

To address this problem, it has been recognised that, in situations such as the mentioned example use cases of [2] in which network access is provided to a UE via a single mobile relay node (e.g. a relay node mounted on a bus or train on which a user with a UE is travelling), there is no need for the UE to regularly perform such measurements. This is because, whilst the user is travelling on the vehicle, the single mobile relay node will be the most suitable serving node. This is especially the case when, for example, the vehicle itinerary has been planned in advance. Power consumption can therefore be reduced by not performing the regular measurements when they are not required. On the other hand, however, the UE must be allowed to start performing regular measurements again when appropriate to prevent connectivity from being lost when, for example, they leave the vehicle and can thus no longer rely on the mobile relay node mounted on the vehicle. There is thus a need to effectively manage whether or not UE-side measurements are performed in different scenarios.

Some of the described examples involve a mobile IAB node as the mobile network node. More generally, however, the mobile network node may be any suitable relay device such as, for example, a relay UE. The described examples may also be implemented by a UE served by a network node which is not a relay node (e.g. donor node 110).

In embodiment(s), the performance of UE measurements is depends on one or more conditions. The condition(s) are based on, for example, time, UE location and UE connection characteristics with one or more specific network nodes. The UE therefore does not always perform measurements on signals transmitted by all network nodes which can potentially serve the UE. Rather, it only performs measurements when required based on fulfilment of the one or more conditions. This helps achieve an appropriate balance between UE measurement performance (allowing the most suitable serving node to be determined, thereby helping maintain UE connectivity with the network through appropriate link switching and/or cell reselection) and UE power consumption (since UE power consumption is reduced when unnecessary measurements are not performed).

In embodiment(s), the term “full UE measurement” refers to the above-described power-consuming performance of measurements by a UE on signals received from all network nodes which can potentially serve the UE. The measurement on each signal may be, for example, a measurement of the Reference Signal Received Power (RSRP) or Reference Signal Received Quality (RSRQ) of a signal transmitted by each network node. The term “measurement configuration” refers to the network node(s) with respect to which measurement is to be performed. For example, the measurement configuration may be full UE measurement or may be that the UE only performs measurement on one node (e.g. the serving node) or a portion of the nodes which can potentially serve the UE.

In an embodiment, a list of preferred nodes and a link quality based measurement are used to determine the type of UE measurement.

For example, a UE which is connected with a relay device, e.g. a network relay (IAB, VMR) or UE relay, will be configured with a preferred measurement list. The preferred measurement list identifies one or more network nodes (e.g. the relay device currently serving the UE and optionally one or more additional network nodes). The preferred measurement list is stored in a storage medium (not shown) incorporated as part of the circuitry of the controller 44, for example.

The UE only performs measurement on the nodes in the preferred measurement list (rather than on all nodes which can potentially serve the UE) unless the radio link quality (e.g. as measured by the RSRP or RSRQ) for at least one node (e.g. all nodes or only a portion of the nodes, depending on the configuration) in the preferred measurement list falls below a threshold. The threshold may be predetermined and may be the same or different for each node in the preferred measurement list. Only when the radio link quality falls below the threshold for the at least one node in the preferred measurement list does the UE start performing full UE measurement.

The preferred measurement list and/or threshold for each node in the preferred measurement list may be indicated to the UE in signalling received from the serving relay device (e.g. when the UE first connects to it).

The preferred measurement list and/or threshold(s) may form new so-called “S-Measure” criteria. Existing S-Measure criteria for non-relay network nodes are discussed in [3], for example. Here, the threshold(s) are for NR SpCell RSRP measurement and control when the UE is required to perform measurements on non-serving cells. The threshold(s) may be based on ssb-RSRP (corresponding to cell RSRP based on the Synchronisation Signal (SS)/Physical Broadcast Channel (PBCH) block) or csi-RSRP (corresponding to cell RSRP based on the Channel State Information Reference Signal (CSI-RS)). This idea can be extended to relay network nodes as new S-Measure criteria which is better tailored to the requirements associated with relay nodes.

For example, the link quality threshold(s) in the new S-Measure criteria may be chosen to reflect the differences between a Uu interface between a UE and a fixed IAB node (with respect to which existing S-Measure criteria are configured) and, for instance, the Uu interface between a UE and a mobile IAB node or the PC5 interface between a remote UE and a relay UE. The link quality threshold(s) may also be more stringent (i.e. indicative of a higher link quality) to reflect the fact that, for example, a small drop in the link quality with a relay device is potentially more problematic than for a fixed network node (since, unlike a fixed network node, the relay device may suddenly move away from the UE it is serving, e.g. if it is mounted on a vehicle the user of the UE has just exited) and thus it may be beneficial for full UE measurement to begin more quickly.

The new S-Measure criteria may be signalled to the UE in a Radio Resource Control (RRC) message (e.g. from an IAB node) or PC5 RRC message (e.g. from a relay UE), for example.

In an embodiment, timing is used to determine the type of UE measurement.

When a UE is configured with a measurement configuration, there will be a time constraint associated with it. For example, the time constraint may comprise:
1) A start time: UE will start performing measurement according to the measurement configuration after the start time.
2) A stop time: UE will stop performing measurement according to the measurement configuration after the stop time.
3) A start time and a stop time: UE will perform measurement according to the measurement configuration between the start time and the stop time.
4) A start time+time period: UE will perform measurement according to the measurement configuration between the start time and the start time+the time period.

The start time, stop time and/or time period may be defined as part of the measurement configuration, for example. The measurement configuration (including the start time, stop time and/or time period, if applicable) may be transmitted to the UE by the serving node.

For example, when a user boards a vehicle and begins being served by a VMR mounted on that vehicle, the measurement configuration may be transmitted to the UE. The measurement configuration may indicate that the UE performs measurement only on the VMR (and no other network nodes) for a duration determined in accordance with a start and stop time of the vehicle, for example. For instance, if the vehicle is a bus or train which departs a first stop at a first time and arrives at a second stop at a second time, the duration may be defined as being between the first time and the second time, with the first time and second time being defined as the start time and stop time, respectively, in the measurement configuration signalled to the UE by the VMR.

This helps reduce UE power consumption when the UE is travelling with the vehicle (since only measurements on the VMR rather than on all detectable network nodes need to be performed) whilst helping ensure connectivity is maintained if the UE leaves the vehicle at one of the stops (since the time at which the UE leaves the vehicle at one of the stops will correspond to the stop time associated with that stop, thereby allowing the UE to begin measurements network nodes other than the VMR). The various start and stop times of the measurement configuration may be determined in advance based on the known route and stopping locations of the vehicle, for example.

More generally, the timings included in a measurement configuration indicate one or more timing-related conditions which must be fulfilled in order for the measurements according to the measurement configuration (e.g. perform full UE measurement or measurement only on UEs on a preferred measurement list) to be carried out. The timing-related condition(s) may be that a time has occurred (e.g. the stop time associated with a vehicle arriving at a stop has occurred), a time has not yet occurred (e.g. the start time associated with a vehicle leaving a stop has not yet occurred), a time period has expired (e.g. a time period between a vehicle leaving a first stop and arriving at a second stop has expired) or a time period has not yet expired (e.g. a time period between a vehicle arriving at a stop and leaving that same stop has not yet expired). Some principles of measurement timing are discussed in [6], for example.

Although the timings in the above examples of this embodiment apply to measurement(s) carried out on node(s) other than the serving node, such timings may also be applied to measurement(s) carried out on the serving node. For example, there may be a measurement configuration which causes the UE to perform measurements on the VMR only at times or during time periods when the vehicle is not moving. This is because, when the vehicle is moving, it is assumed the VMR is the most appropriate serving node (and thus measurements of the VMR are not required) whereas, when the vehicle is not moving, there may be more appropriate serving nodes which could be used (and thus measurements of the VMR, together with measurements on any neighbouring nodes, are required).

In an embodiment, measurement configurations are pre-configured and activated or deactivated to determine the type of UE measurement.

For example, a UE is pre-configured by signalling from the network (e.g. RRC signalling) with one or more measurement configurations (e.g. a first measurement configuration to only perform measurements on the serving node, a second measurement configuration to only perform measurements on nodes in a preferred measurement list, etc.). The UE then only starts performing measurements according to one of the pre-configured measurement configurations if it receives an activation signal from network (e.g. from the current serving node). In general, a pre-configured measurement configuration causes measurement(s) to be performed with respect to the serving node and/or one or more neighbouring nodes.

In an example, each pre-configured measurement configuration is associated with a respective predefined index and the activation signal indicates the index of each measurement configuration(s) which is to be activated. For example, if a first measurement configuration (e.g. only perform measurements on the serving node) with index “1” is to be activated, the activation signal will include the index “1”. Similarly, if a second measurement configuration (e.g. only perform measurements on nodes in a preferred measurement list) with index “2” is to be activated, the activation signal will include the index “2”, and so on. Multiple pre-configured measurement configurations may be activated simultaneously (subject to them not being mutually exclusive) by the activation signal comprising multiple indexes or multiple activation signals each with a different respective index being transmitted.

In an example, the UE will continue performing measurements according to the activated measurement configuration(s) until a subsequent deactivation signal is received from the network (e.g. from the current serving node). The deactivation signal indicates the index of each pre-configured measurement configuration which is to be deactivated.

The activation and deactivation signals may take any suitable form. For example, they may take the form of an activation/deactivation command signalled via RRC signalling, Medium Access Control (MAC) Control Element (CE) signalling or suitable L1 Layer signalling (e.g. Downlink Control Information (DCI)).

The network may transmit an activation or deactivation signal according to one or more characteristics of the UE.

For example, transmission of an activation or deactivation command may be triggered by one or more of:
1) A location report received from the UE (e.g. so the network can activate a measurement configuration for performing measurements on network node(s) in the vicinity of the UE's location)
2) The strength or quality (e.g. RSRP or RSRQ) of an uplink reference signal received from the UE (e.g. so the network can activate a measurement configuration for performing measurements on network node(s) other than the current serving node if the strength of quality of the UE's uplink reference signal falls below a threshold or indicates a UE speed and/or location for which a different pre-configured measurement configuration is appropriate)
3) A known itinerary or route of the UE as it travels (e.g. so the network can activate different pre-configured measurement configurations of the UE at different times and/or locations along the UE's itinerary or route).

In an embodiment, a UE may be required to undertake a single measurement or set of measurements according to a measurement configuration. This may be referred to as a “one shot” measurement configuration. In this case, for example, the need to take measurement(s) according to the one shot measurement configuration is indicated to the UE by predetermined signal transmitted by the network (e.g. the current serving node). Once the measurement(s) are complete (e.g. after a predetermined time period or after a certain number of measurement(s) have been taken), the UE returns to the state it was in before the predetermined signal was received without any further signal (e.g. a deactivation signal) being received from the network. The predetermined signal transmitted to the UE to initiate the one shot measurement configuration may indicate the one shot measurement configuration (e.g. by containing all necessary parameter(s) defining the measurement configuration) or trigger a one shot measurement configuration pre-configured at the UE in advance (e.g. via RRC signalling, MAC CE or Layer 1 signalling).

For example, one shot measurement transmission may be triggered by one or more of:
1. The network wants to know a UE's current location so it can provide proper location based service. In this case, for example, the UE may perform full UE measurement for a limited time in response to the predetermined signal from the network and report the measurement(s) back to the network. Based on the measurement(s), the network can then estimate the location of the UE. Alternatively, if it has the capability to do so, the UE may transmit a location report in response to receiving the predetermined signal from the network.
2. The network wants to know a UE's current radio link quality so it can adjust its beam direction. In this case, for example, the UE may perform measurement on the current serving node with respect to which the beam direction is determined in response to the predetermined signal from the network and report the measurement back to the network. Alternatively, in response to the predetermined signal, the UE may transmit an uplink reference signal which can then be measured by the current serving node to determine the current radio link quality. Based on the measurement (either reported by the UE or measured directly based on the received uplink reference signal), the network can then estimate whether the current beam direction needs to be adjusted.
3. The network wants to check the coverage situation in a specific area. In this case, for example, the predetermined signal is transmitted to all UEs in that area (e.g. by the network node providing a cell covering the area). In response, each UE performs full UE measurement for a limited time in response to the predetermined signal from the network and reports the measurement(s) back to the network.
4. The network wants to know the current interference situation around a specific UE. In this case, for example, the UE may perform a measurement of interfering signal(s) for a limited time in response to the predetermined signal from the network and report the measurement(s) back to the network. This allows the network to determine any network entity likely to cause interference to the UE and take appropriate mitigating action.

The predetermined signal triggering the one shot measurement configuration may take any suitable form. For example, it may take the form of a one shot trigger command signalled via RRC signalling, MAC CE signalling or suitable L1 Layer signalling (e.g. DCI). In general, a one shot measurement configuration causes measurement(s) to be performed with respect to the serving node and/or one or more neighbouring nodes.

The UE may be configured to implement a one shot measurement configuration (e.g. one of the example measurement configurations above) within a predefined period. That is, the UE may be configured such that the action it carries out in response to receiving the predetermined signal from the network (e.g. perform measurement(s) and/or transmit an uplink reference signal) occurs during or at the end of a predetermined time period which is started when the predetermined signal is received. The predetermined time period may be measured in seconds or in radio frames, subframes or slots, for example. This enables the network to know when the action was carried out. This is useful, for example, to help determine any network entity causing interference at the UE (since the network knows when the interference was measured by the UE).

In an embodiment, information indicating the type of UE measurement is indicated in an idle or inactive measurement configuration signal received by the UE from the network. Example idle or inactive measurement configuration signals are disclosed in [4] and configure the UE to perform certain measurement(s) when in an RRC idle or inactive mode. Such signals are comprised in the RRCRelease message, for example.

In an example, for RRC idle mode, the availability of measurement(s) performed by the UE during RRC idle mode are reported to the network in a subsequent RRCSetupComplete message. After security activation (e.g. after transmission of the Security Mode Command to the UE but before reception of the Security Mode Complete from the UE), the network may then request the measurement(s) (which are then provided to the network by the UE).

In an example, for RRC inactive mode, the network can request the UE to provide measurement(s) performed by the UE during RRC inactive mode in the RRCResume message and then the UE can include the available measurement result(s) in the RRCResumeComplete message. Alternatively, the UE may provide an indication of the availability of the measurement result(s) to the network in the RRCResumeComplete message and the network can then request the UE to provide these measurement(s) (which are then provided to the network by the UE).

The type of UE measurement (e.g. a first measurement configuration to only perform measurements on the serving node, a second measurement configuration to only perform measurements on nodes in a preferred measurement list, etc.) can be provided as part of the idle or inactive measurement configuration signal (e.g. in the RRCRelease message and/or System Information Block (SIB) 11 as information element (IE) MeasidleConfig). The type of UE measurement may define further characteristics about the idle or inactive measurement(s) which are to take place. For example, the characteristic could be time-based (e.g. to indicate the time(s) and/or time period(s) that the UE will perform idle or inactive measurement(s)), location based (e.g. to indicate the location/area in which the UE perform idle or inactive measurement(s)) or any other characteristic(s) such as UE speed or the specific network node the UE is connected to before entering idle or inactive mode. Relay node information in may also be included (e.g. in validityAreaList) so, for example, potential relay nodes the UE may encounter in idle or inactive mode can be included in any preferred measurement list.

Although some of the described embodiments relate to L3 Layer measurement reporting, it is noted RSRP and CSI reporting is possible in the L1 Layer (as described in [5], for example). The present technique may therefore be extended to the L1 Layer to enable measurement configuration(s) to be provided to the UE based on time, location, specific network node(s), etc. as described. The type of UE measurement may be configured for the L1 Layer via RRC signalling, for example.

Various embodiments may be combined depending on the requirements of the network. For example, the UE may be configured to only perform measurements on nodes in a preferred network list (subject to the radio link quality for at least one node in the preferred list being above the relevant threshold) on before or after a predetermined time or before or after expiration of predetermined time period. In another example, the UE may be configured to perform only measurements on nodes in a preferred network list (again, subject to the radio link quality for at least one node in the preferred list being above the relevant threshold) but this may be overridden if an activation signal or predetermined signal indicating, for example, full UE measurement is received). It will be appreciated that any of the described embodiments may be combined in accordance with the network requirements.

The present technique thus enables UE measurement to be configured according to one or more conditions to achieve an improved balance between UE connectivity and UE power consumption, particularly in the context of mobile network nodes.

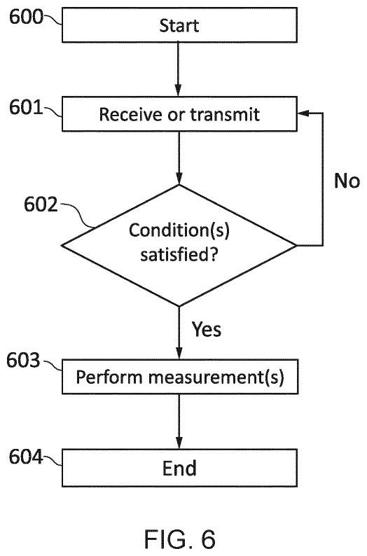

FIG. 6 shows a method carried out by a wireless telecommunications apparatus (e.g. UE 101) according to an embodiment.

The method starts at step 600.

At step 601, communication circuitry (e.g. transmitter 49 and/or receiver 48) transmits wireless signals to or receive wireless signals from a first network node (e.g. node 111), the first network node being a mobile network node.

At step 602, control circuitry (e.g. controller 44) determines whether one or more conditions are satisfied. If the one or more conditions are satisfied, the method proceeds to step 603. Otherwise, the method returns to step 601.

At step 603, the control circuitry measures a characteristic (e.g. RSRP or RSRQ) of a wireless signal received by the communication circuitry from a second, different, network node.

The method ends at step 604.

Various examples have been given of the one or more conditions of step 602. The examples include the condition that a measure indicative of a communication link quality between the wireless telecommunications apparatus and each network node in a list of preferred network nodes is below a communication link quality threshold (wherein the first network node is in the list of preferred network nodes and the second network node is not). The examples also include the condition that a time has occurred (e.g. stop time of a vehicle), a time has not yet occurred (e.g. start time of a vehicle), a time period has expired (e.g. travelling time period of a vehicle) or a time period has not yet expired (e.g. stationary time period of a vehicle). The examples also include the condition that a predetermined signal is received from the network (e.g. from the serving node). The predetermined signal may be an activation signal or predetermined signal triggering a one shot measurement configuration, for example.

A signal indicative of information associated with the one or more conditions may be transmitted by the network to the wireless telecommunications apparatus carrying out the method of FIG. 6. The information may indicate the one or more conditions themselves (e.g. as measurement configuration information, optionally including information such as time(s) or time period(s) if these are included as condition(s)) or information related to one or more conditions when these have been pre-configured at the UE (e.g. the list of preferred network nodes and communication link quality threshold(s) or an index indicating a specific measurement configuration).

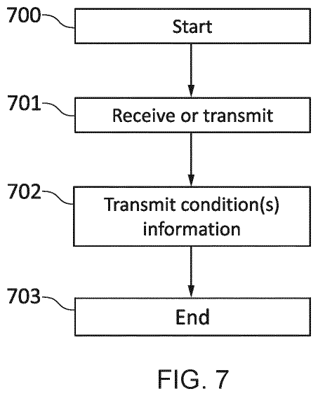

The signal indicative of information associated with the one or more conditions is transmitted by an appropriate node of the network (such as the current serving node). Such a node takes the form of a wireless telecommunications apparatus (e.g. node 111). FIG. 7 shows a method carried out by such a wireless telecommunications apparatus according to an embodiment.

The method starts at step 700.

At step 701, communication circuitry (e.g. transmitter 30 and/or receiver 32) transmits wireless signals to or receive wireless signals from a second wireless telecommunications apparatus (e.g. the wireless telecommunications apparatus carrying out the method of FIG. 6, such as UE 101).

At step 702, the communication circuitry transmits a signal to the second wireless telecommunications apparatus indicative of information associated with the one or more conditions.

The method ends at step 703.

Embodiment(s) of the present disclosure are defined by the following numbered clauses:

Clause 1. A wireless telecommunications apparatus for use in a wireless telecommunications network, the wireless telecommunications apparatus comprising:
communication circuitry configured to transmit wireless signals to or receive wireless signals from a first network node, the first network node being a mobile network node; and
control circuitry configured to:
determine whether one or more conditions are satisfied; and
when the one or more conditions are satisfied, measure a characteristic of a wireless signal received by the communication circuitry from a second, different, network node.

Clause 2. A wireless telecommunications apparatus according to clause 1, wherein:
the first network node is included in a list of preferred network nodes and the second network node is not included in the list of preferred network nodes; and
the one or more conditions comprise a condition that a measure indicative of a communication link quality between the wireless telecommunications apparatus and at least one network node in the list of preferred network nodes is below a communication link quality threshold.

Clause 3. A wireless telecommunications apparatus according to clause 2, wherein the communication circuitry is configured to receive a signal from the network indicating at least one of the list of preferred network nodes and a communication link quality threshold for each network node in the list of preferred network nodes.

Clause 4. A wireless telecommunications apparatus according to any preceding clause, wherein the one or more conditions comprise a condition that a time has occurred, a time has not yet occurred, a time period has expired or a time period has not yet expired.

Clause 5. A wireless telecommunications apparatus according to any preceding clause, wherein the one or more conditions include a current location of the wireless telecommunications apparatus.

Clause 6. A wireless telecommunications apparatus according to any of clauses 1 to 4, wherein the control circuitry is configured to estimate a current location of the wireless telecommunications apparatus, to transmit the estimate of the current location of the wireless telecommunications apparatus to the wireless telecommunications network, and in response, to receive from the wireless telecommunications network an activation command indicating that the wireless telecommunications apparatus should measure the characteristic of the wireless signal received by the communication circuitry or a deactivation command indicating that the wireless telecommunications apparatus should stop measuring the characteristic of the wireless signal.

Clause 7. A wireless telecommunications apparatus according to any preceding clause, wherein the one or more conditions comprise a condition that a predetermined signal is received by the communication circuitry from the network.

Clause 8. A wireless telecommunications apparatus according to clause 7, wherein:
the predetermined signal indicates that the characteristic of the wireless signal received by the communication circuitry from the second, different, network node should be measured a limited number of times and/or for a limited time; and
in response to the communication circuitry receiving the predetermined signal, the control circuitry is configured to measure the characteristic of the wireless signal received by the communication circuitry from the second, different, network node the limited number of times and/or for the limited time.

Clause 9. A wireless telecommunications apparatus according to clause 8, wherein the control circuitry is configured to begin measuring the characteristic of the wireless signal received by the communication circuitry from the second, different, network node during or at the end of a predetermined time period started when the predetermined signal is received.

Clause 10. A wireless telecommunications apparatus according to clause 7, wherein:
the predetermined signal is an activation signal indicating that the characteristic of the wireless signal received by the communication circuitry from the second, different, network node should be measured; and
in response to the communication circuitry receiving the predetermined signal, the control circuitry is configured to measure the characteristic of the wireless signal received by the communication circuitry from the second, different, network node until a deactivation signal is further received by the communication circuitry.

Clause 11. A wireless telecommunications apparatus according to any preceding clause, wherein the communication circuitry is configured to receive a signal from the network indicating the one or more conditions.

Clause 12. A wireless telecommunications apparatus according to clause 11, wherein:
the control circuitry is configured to control the wireless telecommunications apparatus to perform measurements of a characteristic of wireless signals received by the communication circuitry when the wireless telecommunications apparatus is in an idle or inactive mode in accordance with an idle or inactive measurement configuration signal received by the communication circuitry from the network; and
the one or more conditions are indicated by the idle or inactive measurement configuration signal.

Clause 13. A wireless telecommunications apparatus according to any preceding clause, wherein the control circuitry is configured to measure a characteristic of a wireless signal received by the communication circuitry from the first network node when the one or more conditions are satisfied.

Clause 14. A wireless telecommunications apparatus for use in a wireless telecommunications network, the wireless telecommunications apparatus comprising communication circuitry configured to:
transmit wireless signals to or receive wireless signals from a second wireless telecommunications apparatus, the second wireless telecommunications apparatus being configured to transmit wireless signals to or receive wireless signals from a first network node, the first network node being a mobile network node, to determine whether one or more conditions are satisfied, and when the one or more conditions are satisfied, to measure a characteristic of a wireless signal received by the communication circuitry from a second, different, network node; and
transmit a signal to the second wireless telecommunications apparatus indicative of information associated with the one or more conditions.

Clause 15. A wireless telecommunications apparatus according to clause 14, wherein:
the first network node is included in a list of preferred network nodes and the second network node is not included in the list of preferred network nodes;
the one or more conditions comprise a condition that a measure indicative of a communication link quality between the second wireless telecommunications apparatus and at least one network node in the list of preferred network nodes is below a communication link quality threshold; and
the signal transmitted to the second wireless telecommunications apparatus indicative of information associated with the one or more conditions indicates at least one of the list of preferred network nodes and a communication link quality threshold for each network node in the list of preferred network nodes.

Clause 16. A wireless telecommunications apparatus according to clause 14 or 15,wherein:
the one or more conditions comprise a condition that a predetermined signal is received by the second wireless telecommunications apparatus from the network; and
the signal transmitted to the second wireless telecommunications apparatus indicative of information associated with the one or more conditions is the predetermined signal.

Clause 17. A wireless telecommunications apparatus according to clause 16,wherein:
the predetermined signal indicates that the characteristic of the wireless signal received by the second wireless telecommunications apparatus from the second, different, network node should be measured a limited number of times and/or for a limited time.

Clause 18. A wireless telecommunications apparatus according to clause 16,wherein:
the predetermined signal is an activation signal indicating that the characteristic of the wireless signal received by the second wireless telecommunications apparatus from the second, different, network node should be measured; and
the communication circuitry is configured to transmit a deactivation signal to the second wireless telecommunications apparatus indicating that the characteristic of the wireless signal received by the second wireless telecommunications apparatus from the second, different, network node should no longer be measured.

Clause 19. A wireless telecommunications apparatus according to any one of clauses 17 or 18, wherein the signal transmitted to the second wireless telecommunications apparatus indicative of information associated with the one or more conditions indicates the one or more conditions.

Clause 20. A wireless telecommunications apparatus according to clause 19,wherein the signal transmitted to the second wireless telecommunications apparatus indicating the one or more conditions is an idle or inactive measurement configuration signal in accordance with which the second wireless telecommunications apparatus is configured to perform measurements of a characteristic of wireless signals received by the communication circuitry when the second wireless telecommunications apparatus is in an idle or inactive mode.

Clause 21. A wireless telecommunications apparatus according to any preceding clause, wherein the one or more conditions indicate to the second wireless telecommunications apparatus whether to measure a characteristic of a wireless signal received by the second wireless telecommunications apparatus from the first network node.

Clause 22. A wireless telecommunications system comprising a wireless telecommunications apparatus according to clause 1 and a wireless telecommunications apparatus according to clause 14.

Clause 23. A method of controlling a wireless telecommunications apparatus for use in a wireless telecommunications network, the method comprising controlling the wireless telecommunications apparatus to:
transmit wireless signals to or receive wireless signals from a first network node, the first network node being a mobile network node;
determine whether one or more conditions are satisfied; and
when the one or more conditions are satisfied, measure a characteristic of a wireless signal received by the communication circuitry from a second, different, network node.

Clause 24. A method of controlling a wireless telecommunications apparatus for use in a wireless telecommunications network, the method comprising controlling the wireless telecommunications apparatus to:
transmit wireless signals to or receive wireless signals from a second wireless telecommunications apparatus, the second wireless telecommunications apparatus being configured to transmit wireless signals to or receive wireless signals from a first network node, the first network node being a mobile network node, to determine whether one or more conditions are satisfied, and when the one or more conditions are satisfied, to measure a characteristic of a wireless signal received by the communication circuitry from a second, different, network node; and
transmit a signal to the second wireless telecommunications apparatus indicative of information associated with the one or more conditions.

Clause 25. A program for controlling a computer to perform a method according to clause 23 or 24.

Clause 26. A storage medium storing a program according to clause 25.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] Holma H. and Toskala A, “LTE for UMTS OFDMA and SC-FDMA based radio access”, John Wiley and Sons, 2009.
[2] 3GPP TR 22.839 V2.0.0
[3] 3GPP TS 38.331 V16.5
[4] 3GPP TS 38.300 V16.5
[5] 3GPP TS 38.214
[6] WO 2020/030712 A1

1. A wireless telecommunications apparatus for use in a wireless telecommunications network, the wireless telecommunications apparatus comprising:
communication circuitry configured to transmit wireless signals to or receive wireless signals from a first network node, the first network node being a mobile network node; and
control circuitry configured to:
determine whether one or more conditions are satisfied; and
when the one or more conditions are satisfied, measure a characteristic of a wireless signal received by the communication circuitry from a second, different, network node.

2. A wireless telecommunications apparatus according to claim 1, wherein:
the first network node is included in a list of preferred network nodes and the second network node is not included in the list of preferred network nodes; and
the one or more conditions comprise a condition that a measure indicative of a communication link quality between the wireless telecommunications apparatus and at least one network node in the list of preferred network nodes is below a communication link quality threshold.

3. A wireless telecommunications apparatus according to claim 2, wherein the communication circuitry is configured to receive a signal from the network indicating at least one of the list of preferred network nodes and a communication link quality threshold for each network node in the list of preferred network nodes.

4. A wireless telecommunications apparatus according to claim 1, wherein the one or more conditions comprise a condition that a time has occurred, a time has not yet occurred, a time period has expired or a time period has not yet expired.

5. A wireless telecommunications apparatus according to claim 1, wherein the one or more conditions include a current location of the wireless telecommunications apparatus.

6. A wireless telecommunications apparatus according to claim 1, wherein the control circuitry is configured to estimate a current location of the wireless telecommunications apparatus, to transmit the estimate of the current location of the wireless telecommunications apparatus to the wireless telecommunications network, and in response, to receive from the wireless telecommunications network an activation command indicating that the wireless telecommunications apparatus should measure the characteristic of the wireless signal received by the communication circuitry or a deactivation command indicating that the wireless telecommunications apparatus should stop measuring the characteristic of the wireless signal.

7. A wireless telecommunications apparatus according to claim 1, wherein the one or more conditions comprise a condition that a predetermined signal is received by the communication circuitry from the network.

8. A wireless telecommunications apparatus according to claim 7, wherein:
the predetermined signal indicates that the characteristic of the wireless signal received by the communication circuitry from the second, different, network node should be measured a limited number of times and/or for a limited time; and
in response to the communication circuitry receiving the predetermined signal, the control circuitry is configured to measure the characteristic of the wireless signal received by the communication circuitry from the second, different, network node the limited number of times and/or for the limited time.

9. A wireless telecommunications apparatus according to claim 8, wherein the control circuitry is configured to begin measuring the characteristic of the wireless signal received by the communication circuitry from the second, different, network node during or at the end of a predetermined time period started when the predetermined signal is received.

10. A wireless telecommunications apparatus according to claim 7, wherein:
the predetermined signal is an activation signal indicating that the characteristic of the wireless signal received by the communication circuitry from the second, different, network node should be measured; and
in response to the communication circuitry receiving the predetermined signal, the control circuitry is configured to measure the characteristic of the wireless signal received by the communication circuitry from the second, different, network node until a deactivation signal is further received by the communication circuitry.

11. A wireless telecommunications apparatus according to claim 1, wherein the communication circuitry is configured to receive a signal from the network indicating the one or more conditions.

12. A wireless telecommunications apparatus according to claim 11, wherein:
the control circuitry is configured to control the wireless telecommunications apparatus to perform measurements of a characteristic of wireless signals received by the communication circuitry when the wireless telecommunications apparatus is in an idle or inactive mode in accordance with an idle or inactive measurement configuration signal received by the communication circuitry from the network; and
the one or more conditions are indicated by the idle or inactive measurement configuration signal.

13. A wireless telecommunications apparatus according to claim 1, wherein the control circuitry is configured to measure a characteristic of a wireless signal received by the communication circuitry from the first network node when the one or more conditions are satisfied.

14-22. (canceled)

23. A method of controlling a wireless telecommunications apparatus for use in a wireless telecommunications network, the method comprising controlling the wireless telecommunications apparatus to:
transmit wireless signals to or receive wireless signals from a first network node, the first network node being a mobile network node;
determine whether one or more conditions are satisfied; and
when the one or more conditions are satisfied, measure a characteristic of a wireless signal received by the communication circuitry from a second, different, network node.

24. A method of controlling a wireless telecommunications apparatus for use in a wireless telecommunications network, the method comprising controlling the wireless telecommunications apparatus to:
transmit wireless signals to or receive wireless signals from a second wireless telecommunications apparatus, the second wireless telecommunications apparatus being configured to transmit wireless signals to or receive wireless signals from a first network node, the first network node being a mobile network node, to determine whether one or more conditions are satisfied, and when the one or more conditions are satisfied, to measure a characteristic of a wireless signal received by the communication circuitry from a second, different, network node; and
transmit a signal to the second wireless telecommunications apparatus indicative of information associated with the one or more conditions.

25-26. (canceled)
